(19) United States
(12) Patent Application Publication
(10) Pub. No.: US 2018/0240276 A1
(43) Pub. Date: Aug. 23, 2018

(54) METHODS AND APPARATUS FOR PERSONALIZED VIRTUAL REALITY MEDIA INTERFACE DESIGN

(71) Applicant: Vid Scale, Inc., Wilmington, DE (US)

(72) Inventors: Yong He, San Diego, CA (US); Yan Ye, San Diego, CA (US); Srinivas Gudumasu, San Diego, CA (US)

(21) Appl. No.: 15/904,000

(22) Filed: Feb. 23, 2018

Related U.S. Application Data
(60) Provisional application No. 62/462,704, filed on Feb. 23, 2017.

(51) Int. Cl. G06T 19/00; G06T 3/00

(52) U.S. Cl. CPC G06T 19/006; G06T 3/0087

(57) ABSTRACT

Systems, methods, and instrumentalities are disclosed for merging a 2D media element and a spherical media element using a cube mapping format as an intermediate format for a virtual reality environment. The 2D media element may be a 2D rectilinear media element. The spherical media element may be a 360-degree video. The 2D media element and the spherical media element may be received. The 2D media element may be inserted to a square texture face of a cubemap representation. The 2D media element on the square texture face of the cubemap representation may be mapped to an equirectangular format. The 2D media element in the equirectangular format may be rendered with a parameter and the spherical media element. Merging the 2D media element and the spherical media element may be done on a local client side and/or a server side.

### CROSS-REFERENCE TO RELATED APPLICATIONS

The present application claims priority under 35 U.S.C. § 119(e) from U.S. Provisional Patent Application No. 62/462,704, filed Feb. 23, 2017, entitled “PERSONALIZED VIRTUAL REALITY MEDIA INTERFACE DESIGN,” the entirety of which is incorporated herein by reference.

### BACKGROUND

Virtual reality (VR) technologies have been rapidly growing industry with the advancement of other technologies, such as computer technologies, mobile technologies, and/or the high-density displays and graphic technologies. VR devices make it possible to present personalized content beyond the rectilinear models, such as TV or mobile devices. Enhancing user interactions and converging the real and virtual world together can enhance VR experiences.

### SUMMARY

Systems, methods, and instrumentalities are further disclosed for merging a 2D media element and a spherical media element using a cube mapping format as an intermediate format for a virtual reality (VR) environment. A 2D media element may be a 2D rectilinear media element. A spherical media element may be a 360-degree video. The 2D media element and the spherical media element may be received. The 2D media element may be inserted to a square texture face of a cubemap representation. The cubemap representation may be used for the cube mapping format. The 2D media element on the square texture face of the cubemap representation may be mapped to an equirectangular format. The 2D media element in the equirectangular format may be rendered with a parameter and the spherical media element. The parameter may be at least one of a cropping parameter, a rendering parameter, a viewport alignment parameter, a depth parameter, or an alpha channel parameter. Merging the 2D media element and the spherical media element may be done on a local client side and/or a server side.

In some embodiments, at least one input rectilinear media element is inserted to a face of a cubemap representation. The cubemap representation is converted to an equirectangular representation of the rectilinear media element, and the equirectangular representation of the rectilinear media element is merged with an equirectangular representation of an input spherical media element to generate a merged spherical media element. At least a viewport portion of the merged spherical media element is displayed by a client device. The client device may include a head-mounted display, and the viewport portion may be determined based at least in part on an orientation of the head-mounted display. In some embodiments, the converting and the merging are performed by the client device. In other embodiments, the converting is performed by a server remote from the client device. In some embodiments, the merging is performed only for the viewport portion.

The rectilinear media element may be a two-dimensional media element. For example, the rectilinear media element may be a user interface element, a two-dimensional image, or a two-dimensional video. In some embodiments in which the rectilinear media element is a user interface element, user interface elements for different applications are inserted to different faces of the cubemap representation.

In some embodiments, the merging is performed by overlaying the equirectangular representation of the rectilinear media element on the equirectangular representation of the input spherical media element. In some embodiments, the merging is performed using alpha compositing of the equirectangular representation of the rectilinear media element with the equirectangular representation of the input spherical media element.

In a method according to some embodiments, a rectilinear input media element is mapped to an equirectangular representation by a method that includes, for each of a plurality of equirectangular sample positions in the equirectangular representation: (i) mapping the respective equirectangular sample position to a corresponding cubemap position in a cubemap representation, (ii) mapping the corresponding cubemap position to an input sample position in the input media element, and (iii) setting a sample value at the respective equirectangular sample position based on a sample value at the input sample position. The resulting equirectangular representation of the input media element is merged with an equirectangular spherical media element to generate a merged spherical media element.

In a method according to some embodiments, a first mapping of an input rectilinear media element to a position in a first rectilinear projection is selected. The mapping may include, for example, translation, scaling, and/or rotation of the input element. The input media element is converted to an equirectangular representation. The conversion to the equirectangular representation may be performed by applying the first mapping and a second mapping, where the second mapping is a mapping between the first rectilinear projection and the equirectangular representation. The converted media element may be merged with an equirectangular spherical media element to generate a merged spherical media element. The merged spherical media element, or at least a viewport portion thereof, may be displayed on a client device.

In some embodiments, a first mapping is selected, wherein the first mapping is a mapping of an input rectilinear media element to a position in a first projection format, and wherein the position corresponds to a rectilinear portion of the first projection format. The rectilinear media element is converted to an equirectangular representation by applying the first mapping and a second mapping, wherein the second mapping is a mapping between the first projection format and the equirectangular representation. The converted rectilinear media element is merged with another equirectangular media element to generate a merged media element. The merged spherical media element, or at least a viewport portion thereof, may be displayed on a client device.

In some embodiments, a system is provided, where the system includes a processor and a non-transitory computer-readable storage medium. The storage medium stores instructions that are operative, when executed on the processor, to perform the functions described herein.

In some embodiments, a 2D media element and a spherical media element are received, wherein the spherical media element is a 360-degree video. The 2D media element and the spherical media element are merged using a cube mapping format for a virtual reality (VR) environment, wherein the cube mapping format is used as an intermediate format. In some such embodiments, the merging of the 2D media element and the spherical media element includes (i) inserting the 2D media element to a square texture face of a cubemap representation, where the cubemap representation is used for the cube mapping format; (ii) mapping the 2D media element on the square texture face of the cubemap representation to an equi-rectangular format, and (iii) rendering the 2D media element in the equi-rectangular format with a control parameter and the 360-degree video. The control parameter may be, for example, a cropping parameter, a rendering parameter, a viewport alignment parameter, a depth parameter, or an alpha channel parameter. The merging of the 2D media element and the spherical media element may be done on a local client side or on a server side.

### BRIEF DESCRIPTION OF THE DRAWINGS

FIG. 1 depicts an example of rectilinear projection.

FIG. 2 depicts an example of equirectangular projection (ERP) for a 360° video.

FIG. 3 depicts an example of cube mapping for a 360° video.

FIG. 4A illustrates an example of an ERP frame, and FIGS. 4B and 4C illustrate two examples of cubemap packing formats.

FIG. 5 depicts an example of viewport example of a head mounted display (HMD).

FIG. 6 depicts an example of real-time overlay of rectilinear media over a 360-degree video according to an embodiment.

FIGS. 7A-7C illustrate an example of media insertion (e.g., rectilinear video insertion) to virtual reality (VR) according to an embodiment.

FIGS. 8A-8B depicts an example of generating an equirectangular representation for the front texture face in the cubemap representation of FIG. 7C according to an embodiment.

FIG. 9 depicts an example of media insertion (e.g., rectilinear video insertion) being overlaid onto a portion of the 360-degree video according to an embodiment.

FIG. 10 is a functional block diagram illustrating a system in which media conversion is performed at a client device according to an embodiment.

FIG. 11 is a functional block diagram illustrating a system in which media conversion is performed on a server separate from the client device according to an embodiment.

FIG. 12 is a schematic illustration of insertion of multiple rectilinear media elements into a VR environment according to an embodiment.

FIG. 13 depicts an example of user interface (UI) layout in a VR environment according to an embodiment.

FIGS. 14A-14C illustrate an example configuration of UI icons showing opaque UI elements, transparent UI elements, and activated UI elements according to an embodiment.

FIG. 15 schematically illustrates an example VR layer switching according to an embodiment.

FIG. 16A is a system diagram of an example communications system in which one or more disclosed embodiments may be implemented.

FIG. 16B is a system diagram of an example wireless transmit/receive unit (WTRU) that may be used within the communications system illustrated in FIG. 16A.

FIG. 16C is a system diagram of an example radio access network and an example core network that may be used within the communications system illustrated in FIG. 16A.

FIG. 16D is a system diagram of another example radio access network and an example core network that may be used within the communications system illustrated in FIG. 16A.

FIG. 16E is a system diagram of another example radio access network and an example core network that may be used within the communications system illustrated in FIG. 16A.

FIG. 17 is a flow chart illustrating a method performed in some embodiments.

FIG. 18 is a flow chart illustrating a method performed in an alternative embodiment.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Immersive Virtual reality (VR) technologies have become more popular with the advancement of computer technologies, mobile technologies, and high-density displays and graphics technologies. A number of VR headsets and devices have been released. VR may be further driven by increases in the power of artificial intelligence computing, large data transmission speeds, ubiquity of cheap and sophisticated sensors, and user interfaces. The user interface may be operated using physical interactions, social interactions and/or personal interactions.

Virtual reality experiences have been improving over time. However, VR-virtual representations of real places taken from video, such as 360-degree video, may lack some or all types of interactivity. A 360-degree video may be able to deliver immersive experience to users. More live 360-degree video services may have been introduced into social networking and live broadcasting. Instead of watching highly processed or staged 360-degree video, people may look for greater realism within 360-degree video. Interactive VR may allow people to become entrenched in the new reality, such as looking, touching or otherwise experiencing an explosion of the senses. Interaction in 360-degree video may be based on, for example, head-tracking technology. The head-tracking technology may use sensors to monitor the position of user's head, and the position of the user's head may be translated into actions. Head-tracking technology may be built into headsets and/or may function on sensor-laden smartphones. Hand tracking devices may be provided. Examples of hand tracking devices include a set of button-bedecked, hand-held trackable controllers and/or a wireless controller. Gloves that may bring movement of the hands and fingers into a virtual world may be provided. By wearing finger-tracking gloves, the user may be able to type on a virtual keyboard or may draw with a high degree of accuracy. Other interaction technologies, such as eye-tracking, lip-tracking and/or face- or emotion-tracking technologies, may be provided.

Some or all VR applications and/or gadgets may provide the immersive virtual experience in a self-contained and/or isolated VR space with various degrees of freedom, such as three degrees of freedom (3DoF). People may not feel comfortable being sealed off from reality in an unfamiliar world without interaction with the real world and/or real people. In some cases, VR may enable a greater number of degrees of freedom, such as six degrees of freedom (6DoF). 6DoF in VR may blend real world into VR environment and may make VR social and may provide an immersive experience. A number of technologies have been focusing on bringing the real world into the virtual reality headset for augmented reality (AR) or mixed reality (MR) experience. For example, a VR headset may be equipped with a camera array with the capability to make a 3D map of any room and of objects in the room. The VR headset may enable a merged reality which may merge the real world into the virtual simulation. Another example of VR headset is a headset with a front-facing camera-sensor to allow VR users to glimpse the real world within VR. Such a VR headset may support 6DoF and may rely on, for example, external lighthouses and/or sensor systems to position the headset wearer in a room. Another example of a VR headset is a smartphone capable of blending AR and/or VR. The smartphone may be compatible with various VR headsets and applications. The smartphone may have, for example, a revamped tri-camera system that achieves depth sensing 3D scanning and/or augmented reality. An AR and/or VR-ready mobile platform or an all-in-one VR headset may be used for mixed reality and/or augmented reality to bridge the gap between smartphone VR and PC VR.

Virtual reality may enhance user interactions and may bring the real world and virtual world together. Virtual reality may overlap with other technologies, such as health, biotech, robotics, video, wearable and/or vehicle technologies. Virtual reality may change the day-to-day lived experience. The daily human experience may be integrated with VR, analogous to the integration of daily human experience with smartphone applications.

360-degree video may be one of the components of VR. 360-degree video may be captured and/or rendered on, for example, a sphere. Such spherical video format cannot generally be delivered directly using conventional video codecs. Rather, encoding of a 360° video or spherical video is often performed by projecting the spherical video onto a 2D plane using some projection method and subsequently coding the projected 2D video using conventional video codecs.

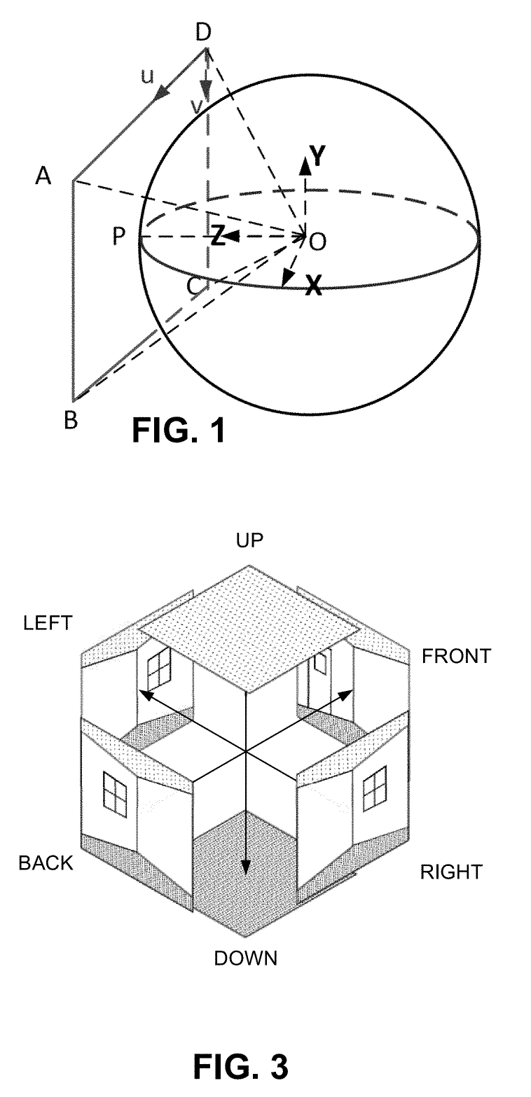

One type of projection used in panoramic imaging is rectilinear projection, since most (non-fisheye) camera lenses produce an image close to being rectilinear over the entire field of view. In rectilinear projection, straight lines in real 3D space are mapped to straight lines in the projected image. In rectilinear projection, each pixel of the sphere is re-projected on a plane tangential to the sphere, as shown in FIG. 1. Only the pixels facing the plane can be projected, and those pixels located outside will be strongly stretched.

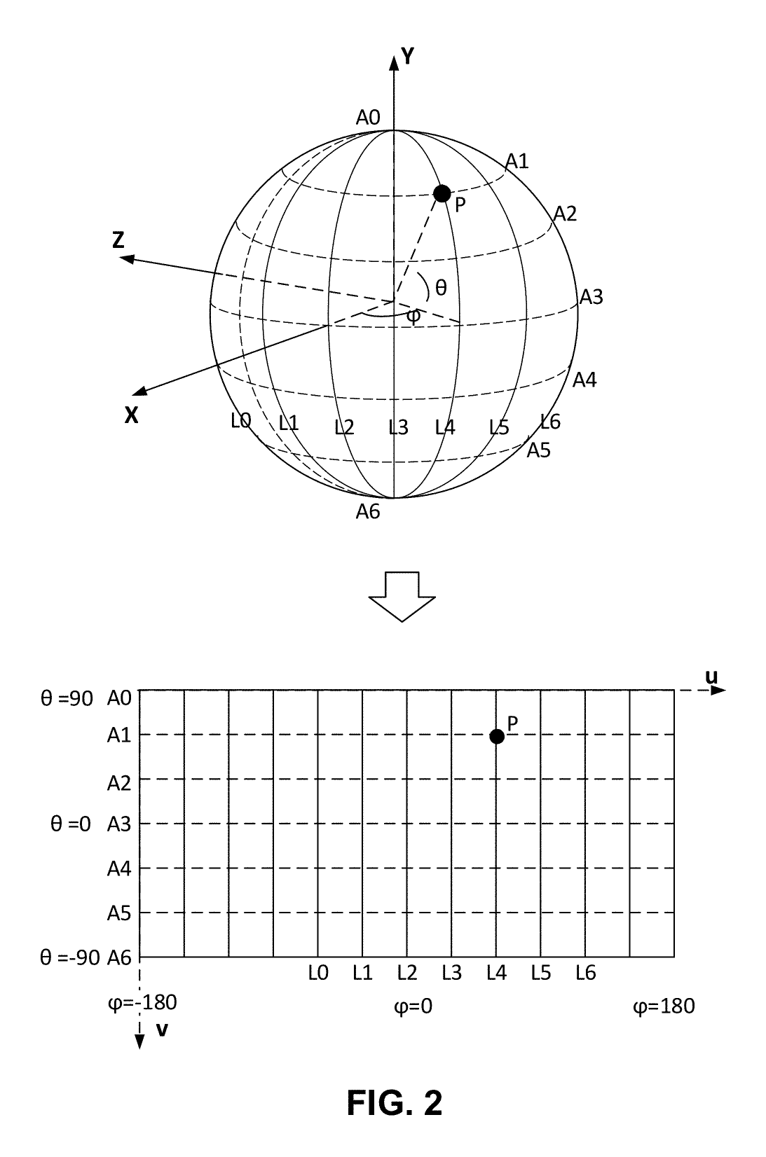

Equirectangular projection (ERP) is a projection method that is commonly used for 360-degree imaging. One example of ERP is provided by Equations 1 and 2, which map a point P with coordinate (θ, φ) on a sphere to a point P with coordinate (u, v) on a 2D plane, as shown in FIG. 2.

u=ϕ/(2π)+0.5 (Eq. 1)

v=0.5−θ/(π) (Eq. 2)

Cube mapping is another one of the projection methods for 360-degree video mapping. The cubemap is generated by rendering the scene six times from a viewpoint, with the views being defined by a 90-degree view frustum representing each cube face. FIG. 3 illustrates an example of cube mapping and six faces. Each cube face shown in FIG. 3 is generated with a rectilinear projection. Projections such as the cubemap are piecewise rectilinear in that they are rectilinear within each cube face, but a real-world straight line that crosses from one face to another is not guaranteed to be mapped to a straight line in the 2D projection. However, the term rectilinear projection as used herein encompasses piecewise rectilinear projections such as cube mapping. Similarly, in some embodiments, a projection may be used that is rectilinear in some regions but not rectilinear in other regions. For the sake of clarity, the use of a rectilinear portion of such a projection is referred to herein as use of a rectilinear projection.

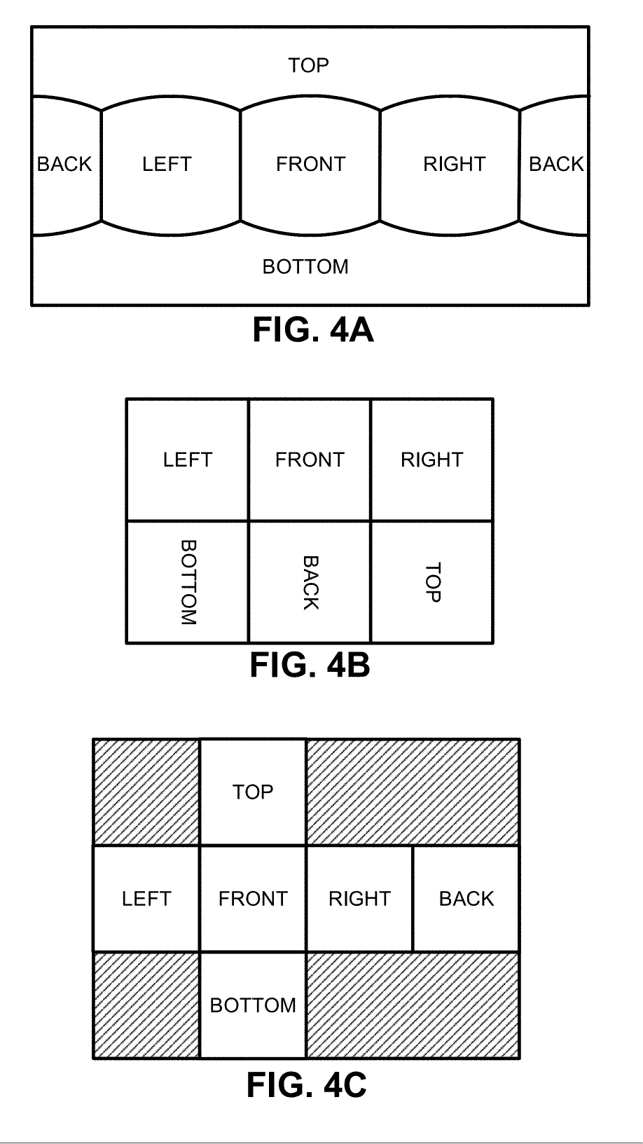

Various different packing formats may be used to arrange the six cube mapping faces into a video frame. FIGS. 4A-4C illustrate an example of an ERP frame, shown in FIG. 4A, and two cubemap packing formats, shown in FIGS. 4B and 4C. The conversion between equirectangular and cube map may be performed via software and/or hardware tools.

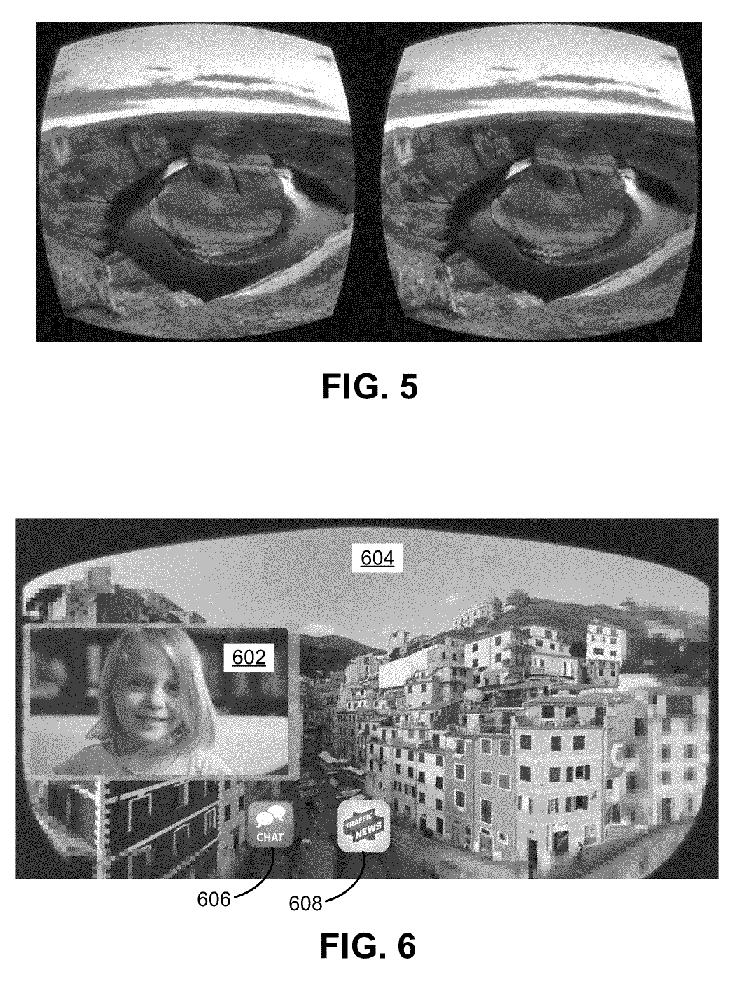

When viewing a 360° video, the user may be presented with a part of the video, as shown in FIG. 5. When looking around or zooming, the part of the video may change based on, for example, the feedback provided by the Head Mounted Display (HMD) or other types of user interface (e.g., smartphones). A spatial region of the 360° video that is presented fully or partially to the user is referred to as a viewport. The viewport may have different quality than other parts of the 360° video. In some HMD systems, a different viewport is presented for each eye, as illustrated in FIG. 5.

VR is known as a platform for delivering immersive fantasy entertainment experiences. However, it would be desirable for VR to integrate functions of daily life, including communicating with others through video, text, and other media. Exemplary embodiments described herein provide a VR user interface (UI) that allows users to stay in connection with the users' lives in the real world. Such VR UI embodiments may allow users to explore the alternative reality while also viewing one or more other media elements, such as rectilinear images or video, in a VR environment. Ability to simultaneously stay connected to the real world and experience an immersive VR session may be referred to as personalized VR.

Conventional devices such as TV, desktop/laptop, tablet and/or smartphone, generally present media elements rectilinearly through 2D flat surfaces. Windows, tabs, icons and buttons are examples of UI elements employed on these devices. Comparted to such conventional devices, VR devices may provide a three-dimensional space in which interactions are possible.

This disclosure describes a number of exemplary embodiments to support personalized VR. Exemplary embodiments allow users to interact and manage real world personalized media elements while immersed in a VR environment.

A VR device may present personalized content beyond the rectilinear models, such as TV or mobile devices. In exemplary embodiments, one or more media elements such as video, image, animation, or a digital object may be presented to the user at a certain time instance or picture-in-picture. Picture-in-picture may refer to the case when a media source, which may be a secondary media source, is shown together with another media source, which may be a first or primary media source, in overlaid windows in order to, for example, accommodate limited display surface area. VR may offer an entire 360-degree space with, for example, 6DoF motion tracking capability which may enable personalized interactive experience. VR devices and/or applications may create more augmented reality experiences, such as location-based AR games, or mixed reality experience by converging the real world with the digital objects which may extend the user's activities.

ERP is a projection format that is commonly used in VR applications and devices. ERP, however, has issues that are inherent in sphere mapping, such as image distortion, viewpoint dependency computational inefficiency. Rectilinear projections such as cube mapping, however, overcome some of the issues of ERP.

Some VR devices are capable of rendering either 360-degree video or rectilinear video, but in general, those devices are not capable of rendering both 360-degree video and rectilinear video at the same time. For example, a VR device may use file extension to identify whether the content is spherical or rectilinear, or a VR device may require a user to manually configure the input type to identify the content and/or render accordingly. However, many existing applications and non-VR media elements are in a rectilinear format. Exemplary embodiments described herein provide the capability to mix 360-degree video and conventional rectilinear media elements (such as 2D video, image and text) together and render them in real time within the same VR environment. In some embodiments, the VR user may carry out a live video chat using the rectilinear video format with the user's family or friends while exploring 360-degree VR immersion as shown in FIG. 6. Using techniques described in greater detail below, in the embodiment illustrated in FIG. 6, a rectilinear video 602, such as a video received through a video chat application, is processed and displayed as an overlay within a viewport 604 of a spherical video. Rectilinear user interface elements such as icons 606, 608 may also be displayed using techniques described herein.

In cube mapping, the video signal inside each face is in a rectilinear projection. In exemplary embodiments, the cube mapping format or other rectilinear projection format is used as an intermediate format to merge video signal in rectilinear format and video signal in spherical format (e.g., 360-degree format) together onto a spherical surface in real time.

Each cube face is a square containing a rectilinear viewport from a 360-degree image and/or video. A VR rendering module projects each face to the corresponding part of the spherical surface. In some embodiments, a 2D rectilinear media element such as video, image and/or text is presented in a VR environment by utilizing such a cube mapping feature. Techniques for conversion of a 2D rectilinear media element into a VR environment are described herein.

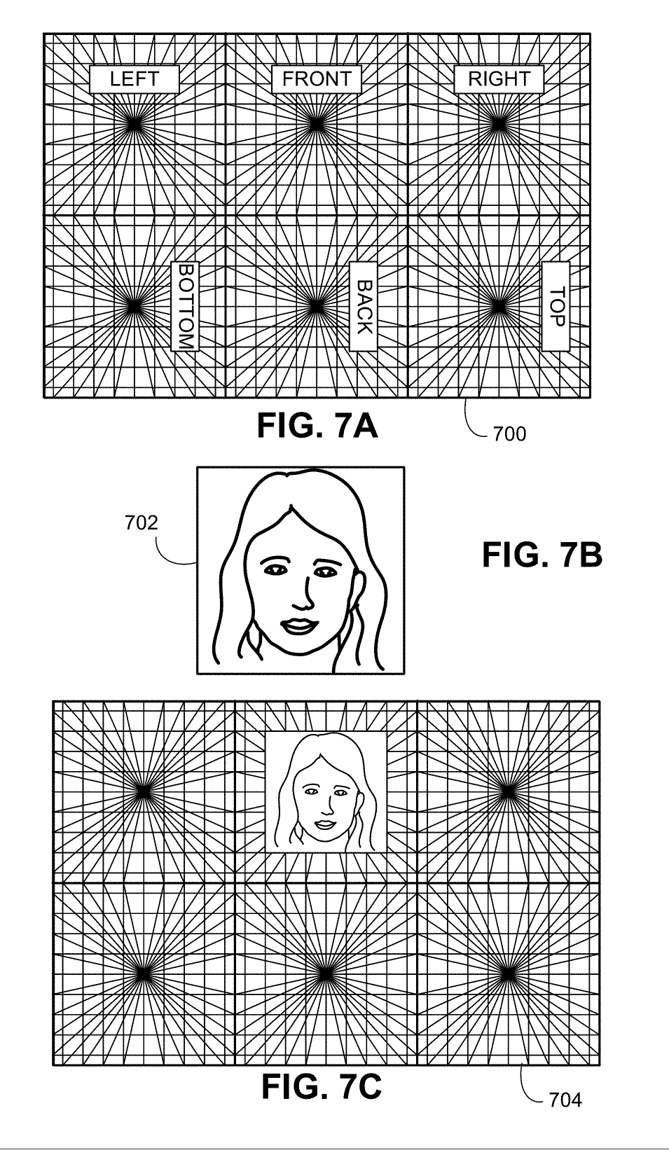

In an exemplary embodiment, a rectilinear media element, such as a rectilinear video, image and/or text element, is copied to one or more square texture face(s) of a cubemap representation. The media element may be, for example, square or rectangular. FIG. 7A illustrates a grid on a cubemap representation 700. FIG. 7B illustrates a rectilinear media element 702, in this case an image (which may be a frame of video), that is to be displayed in VR. As illustrated in FIG. 7C, the media element 702 is inserted in the “front” face of the cubemap representation 700 to generate representation 704. Preferably, the entire image is contained within a single face of the cube. The image may be scaled, cropped, or otherwise processed prior to insertion into the cubemap representation.

After the insertion of the rectilinear media element into the cubemap representation, at least the portion of the cubemap that includes the rectilinear media element is mapped to an equirectangular format. In some embodiments, an entire face is mapped to the equirectangular format. In some embodiments, the entire cubemap representation is mapped to the equirectangular format (e.g., when media elements have been inserted in more than one of the faces). This mapping may be performed by a software and/or hardware tool. A face index (e.g., an index identifying the front, left, right, back, top or bottom face) may be provided to the tool to identify the face or faces to be mapped.

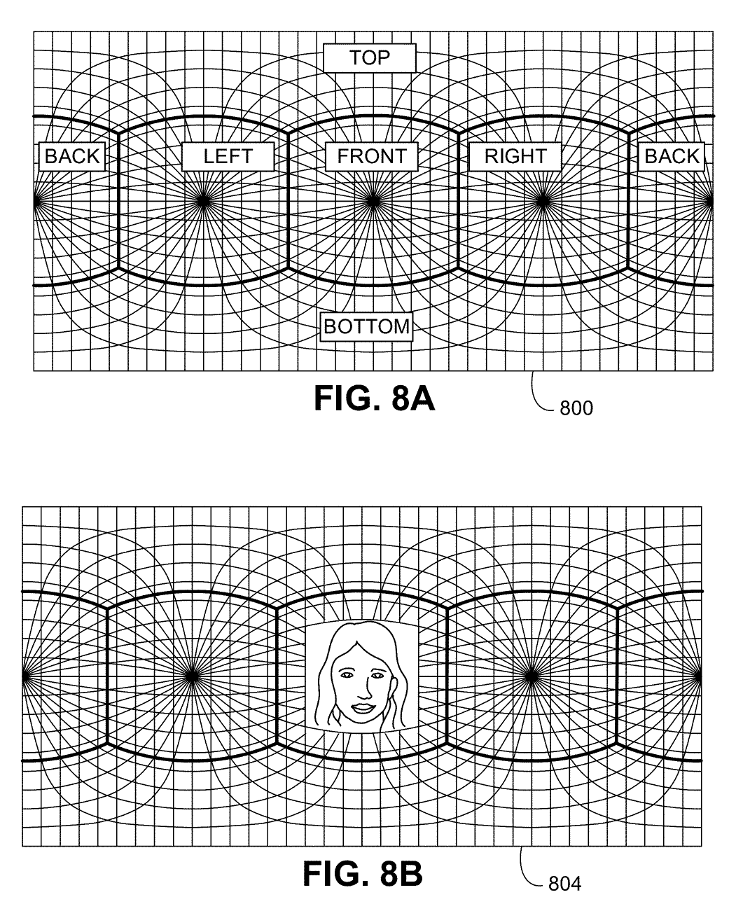

FIG. 8A illustrates an equirectangular representation 800 in which the grid from the cubemap representation 700 (FIG. 7A) has been transformed to the equirectangular representation. FIG. 8B illustrates a transformation of the cubemap representation 704 to the equirectangular representation.

In an exemplary embodiment, the mapped representation (e.g. image or video) in equirectangular format, such as representation 804, is provided to a VR rendering module. In addition, viewable range parameters, such as position, and/or range parameters, may be provided to the VR rendering module. The rendering module may carry out alpha compositing of some or all visible layers including the sphere layer with 360-degree video content. The VR rendering module may be provided by hardware-based devices or software-based player. Parameters (e.g., position parameters and/or range parameters) may specify how to present the mapped video. In one example, cropping parameters may be specified in the rectilinear viewport domain. When the mapped video is being rendered into the rectilinear viewport, a cropped portion may be presented. For example, as shown in FIG. 6, the rectilinear media element may be rectangular in shape. In some embodiments, the mapped video contains white margins that are not part of the original rectilinear media content. A rectangular cropping window in the rectilinear domain may be specified to present the meaningful content in the rendered viewport image. In another example, parameters associated with the viewable areas of the mapped content may be specified in the spherical domain. A center viewpoint and/or the ranges of pitch and yaw may be specified for the mapped content in the equirectangular domain.

In another example, the corresponding parameters to specify cropped portion of the rectilinear viewport and/or viewable areas of the mapped content in the spherical domain may be signaled as metadata for personalized VR content distribution. The signaling may allow a conversion such as that described herein (e.g., copying the rectilinear media element to a particular square texture face of cube and/or mapping the corresponding texture face to equirectangular format) to be applied to the rectilinear media elements at local client side. The signaling may allow the conversion described herein to be performed at the server side. The server may carry out the conversion using the parameters signaled to the server. In such an embodiment, the client may fetch the merged content from the server without performing additional processing. The computation load at the client side may be reduced if the server fetches the merged content from the server. Table 1 and Table 2 show examples of the signaling of cropping parameters and/or viewable area rendering parameters for personalized VR content distribution. The signaling syntax may be carried in VR application format, such as Omnidirectional Media Application Format, to indicate the viewable area for omnidirectional media storage and metadata signaling in, for example, ISO base media file format (ISOBMFF).

The signaling may be carried in, for example, the Media Presentation Description (MPD) file of MPEG-DASH to describe the viewable area of the corresponding media content in a streaming service. The signaling may be carried in server and network assisted (SAND) DASH message to be exchanged between the DASH-aware elements such as DASH server, client, cache and/or metrics servers. The signaling syntax may be applied to other VR content distribution protocols or manifest files.

TABLE 1
Cropping parameters of viewable area within the rectilinear viewport
domain

| Syntax | Semantics |
|---|---|
| Cropping_parameters ( ) { | |
| viewport { | |
| viewport_center_x | Decimal floating value may specify the |
| | horizontal coordinate of the viewport |
| | center position |
| viewport_center_y | Decimal floating value may specify the |
| | vertical coordinate of the viewport center |
| | position |
| viewport_width | Decimal floating value may specify the |
| | viewport width |
| viewport_height | Decimal floating value may specify the |
| | viewport height |
| } | |
| viewable area { | |
| viewable_center_x | Decimal floating value may specify the |
| | horizontal coordinate of center position of |
| | the viewable area within the viewport |
| viewable_center_y | Decimal floating value may specify the |
| | vertical coordinate of center position of the |
| | viewable area within the viewport |
| viewable_width | Decimal floating value may specify the |
| | viewable area width |
| viewable_height | Decimal floating value may specify the |
| | viewable area height |
| } | |

TABLE 2
Rendering parameters of viewable area within the spherical domain

| Syntax | Semantics |
|---|---|
| Cropping_parameters ( ) { | |
| viewport { | |
| viewport_center_yaw | Decimal floating value may specify the |
| | yaw of the viewport center position |
| viewport_center_pitch | Decimal floating value may specify the |
| | pitch of the viewport center position |
| viewportyaw_range | Decimal floating value may specify the |
| | horizontal field of view of the viewport |
| viewport_pitch_range | Decimal floating value may specify the |
| | vertical field of view of the viewport |
| } | |
| viewable area { | |
| viewable_center_yaw | Decimal floating value may specify the |
| | yaw of the viewable area center position |
| viewable_center_pitch | Decimal floating value may specify the |
| | pitch of the viewable area center |
| | position |
| viewable_yaw_range | Decimal floating value may specify the |
| | horizontal viewable range in spherical |
| | domain |
| viewable_pitch_range | Decimal floating value may specify the |
| | vertical viewable range of the viewport |
| } | |

The rendering module may take inputs such as one or more rectilinear video content(s) and/or the 360-degree video content (e.g., in equirectangular format) to be rendered as a background layer. The rendering module may take the mapped content (e.g. in equirectangular format) including one or more rectilinear video portion(s) composited, along with the associated viewable area parameters (e.g., position parameter and/or range parameter) and/or other parameters such as alpha channel parameters used for alpha compositing. The rendering module may output a viewport image with the rectilinear media element overlaid onto the 360-degree content within the viewport image.

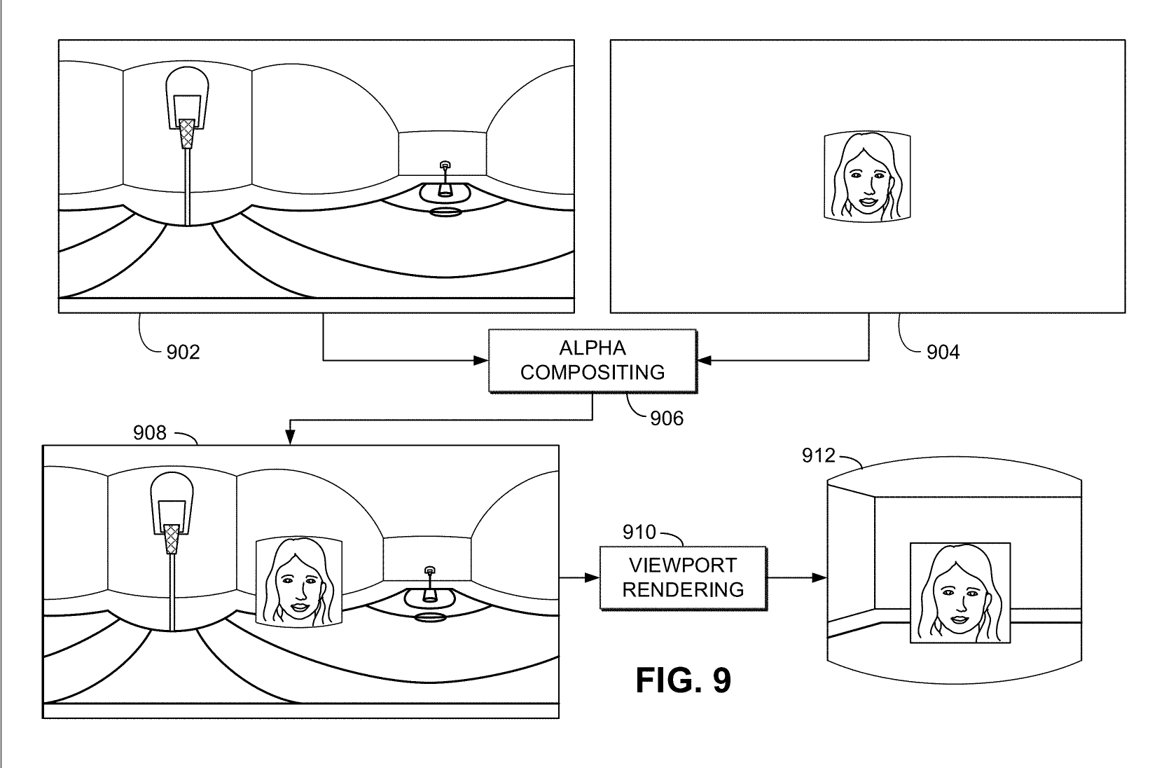

FIG. 9 illustrates an example of using a conversion method according to embodiments described herein to pass the mapped rectilinear video and 360-degree video to a VR rendering module. The mapped rectilinear video and the 360-degree video may be in ERP format. FIG. 9 illustrates a spherical video 902 and an equirectangular representation 904 of a rectilinear video. The rendering module performs alpha compositing to overlay the representation 904 on the spherical video 902 to form a composite video 908. The rendering module further operates in step 910 to render a viewport 912 to be displayed to the user. (A barrel or pincushion distortion, not shown, may be applied the to viewport 912 to counteract distortion introduced by display optics. The region of the video 908 that is displayed to the user may be selected based on tracking of the users viewing direction. The output of the rendering module may be an image with the rectilinear video being overlaid onto a portion of the 360-degree video that may correspond to a viewport image. While FIG. 9 illustrates alpha compositing being performed for the entire representation of the spherical video, in some embodiments, the alpha compositing is performed only for those regions that have been determined to be in a viewport to be rendered.

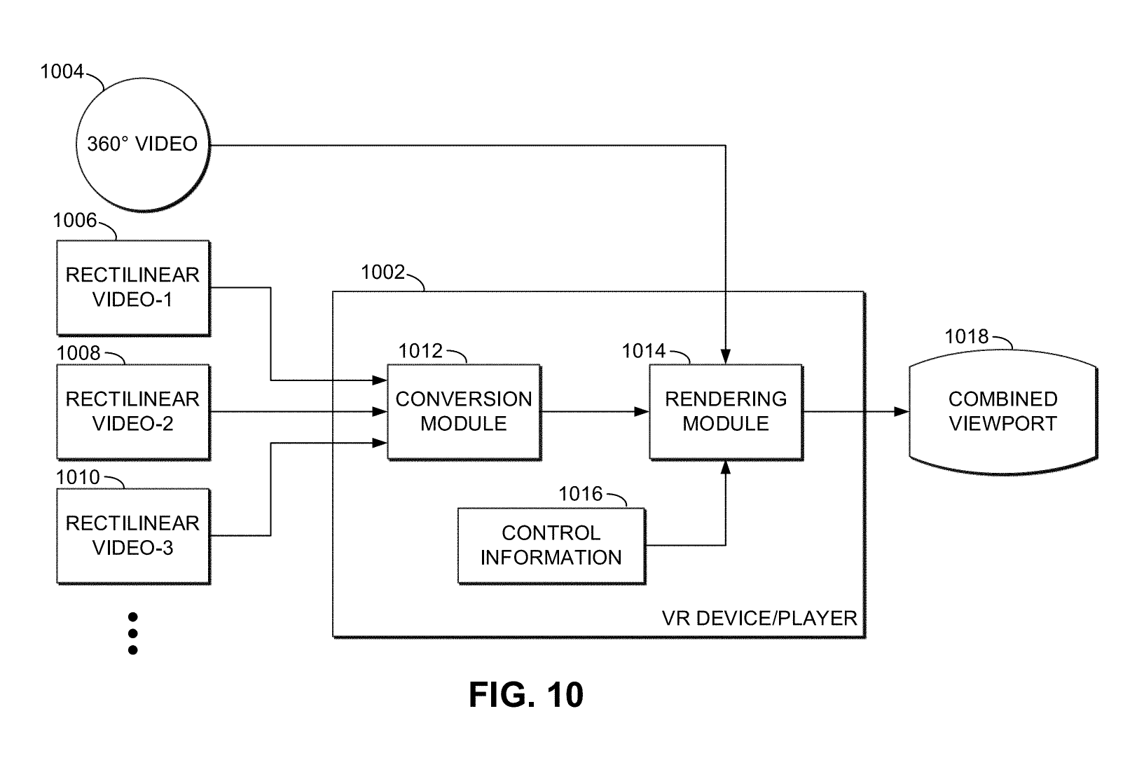

In some embodiments, the conversion module and/or VR rendering module resides on the client side, e.g. in a VR device/player 1002, as shown in the system diagram of FIG. 10. A 360-degree video 1004 and/or one or more rectilinear 2D video(s) 1006, 1008, 1010 may be one or more input(s) into VR devices and/or application, as shown in FIG. 10. The 360-degree video may be rendered on a single sphere layer, which may be a primary sphere layer. The depth of the primary sphere layer may be based on a default value set by the device. The device may also implement one or more additional sphere layers. The additional sphere layer(s) may have adjustable depths. A conversion module 1012 may map one or more rectilinear video(s) into ERP viewport as described herein. For example, one or more rectilinear video(s) may be copied into one or more square texture face(s) of cubemap representation, as shown in FIG. 7. The cubemap representation may be converted to ERP, as shown in FIGS. 8A-8B. The conversion module may pass the rectilinear video mapped content (e.g. multiple rectilinear video mapped contents, each rendered on one sphere layer) to the rendering module 1014 with one or more control parameters 1016. The one or more control parameters may be cropping parameters of viewable area within the rectilinear viewport domain (e.g., Table 1), rendering parameters of viewable area within the spherical viewport domain (e.g., Table 2), viewport alignment parameters, depth parameters, and/or alpha channel parameters. The rendering module may carry out, for example, alpha blending to composite a 360-degree video from one sphere layer (e.g., primary sphere layer) and one or more rectilinear video(s) on other sphere layers to present to the user as a combined viewport 1018.

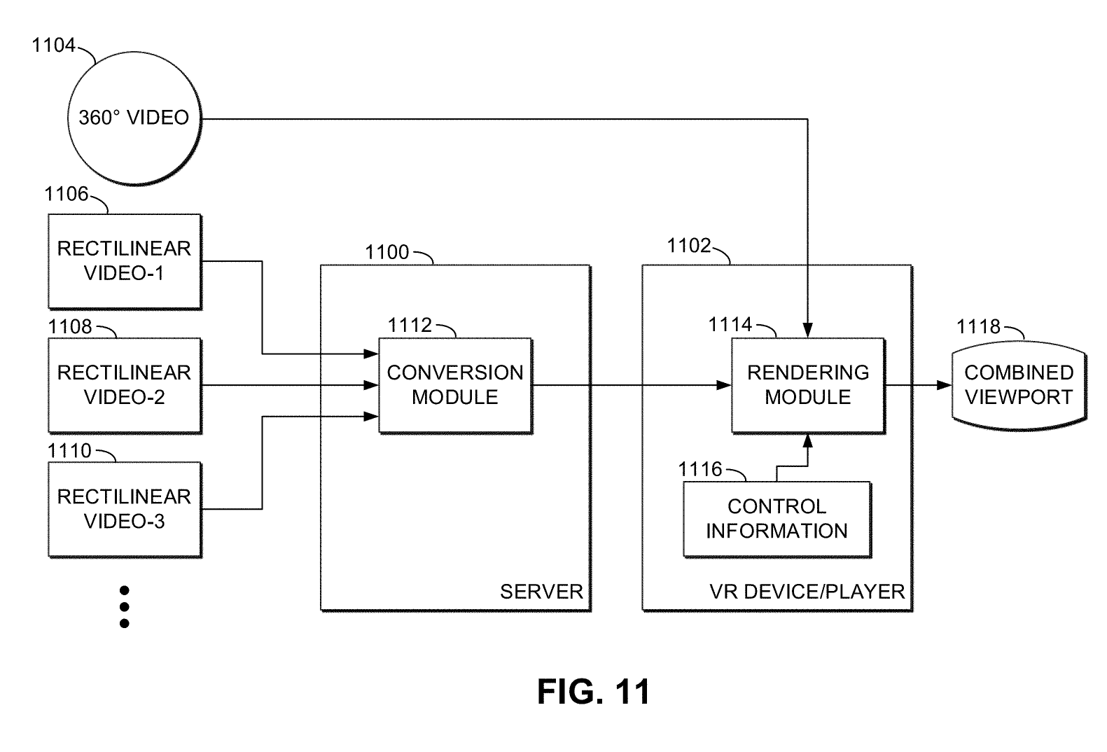

The conversion module 1112 may reside on the server side, as shown in the system diagram FIG. 11. The client may fetch the 360-degree video 1104 and/or one or more rectilinear 2D video(s) mapped contents from the server 1100. The conversion module 1112 may map one or more rectilinear video(s) 1106, 1108, 1110 into an ERP viewport as described herein. For example, one or more of the rectilinear videos may be copied into one or more square texture faces of cubemap representation, as shown in FIG. 7. The cubemap representation may be converted to ERP, as shown in FIGS. 8A-8B. The conversion module 1112, which may reside on the server side, may pass the rectilinear video mapped content to the rendering module 1114 at client device 1102 with one or more control parameters 1116. One or more control parameters may be cropping parameters of viewable area within the rectilinear viewport domain (e.g., Table 1), rendering parameters of viewable area within the spherical viewport domain (e.g., Table 2), viewport alignment parameters, depth parameters, and/or alpha channel parameters. The rendering module 1114 may carry out alpha blending to composite a 360-degree video on one sphere layer (e.g., primary sphere layer) and one or more rectilinear video(s) on other sphere layers to present to the VR user as a combined viewport 1118.

If cubemap projection is supported in the rendering module, the cubemap to ERP conversion module may be bypassed. The cubemap representation may comprise one or more rectilinear video(s). The cubemap representation may be passed directly to the rendering module. The rendering module may support a mixture of formats (e.g., the 360 video of the primary sphere may be provided to the rendering module in the ERP format, and the rectilinear videos composited onto a secondary sphere may be provided to the rendering module in the cubemap format). The relative control parameters such as viewable area within the cubemap face may be used by rendering module.

As shown in FIG. 6, exemplary media elements may include a video or graphic signal in the rectilinear format, such as a live chat video 602, chat icon 606, and a traffic/news icon 608. The media elements may be inserted into the VR environment using a cube mapping approach as provided herein. A projection format conversion process from cubemap to equirectangular described herein (e.g., FIGS. 8A-8B) may run in real-time. For example, coordinate conversion in Lookup Tables (LUTs) may be pre-stored. Single Instruction, Multiple Data (SIMD) programming may be applied in texture rendering stage. In hardware-based implementations, for example, dedicated ASIC or texture rendering engines in GPUs may be used. One or more rectilinear media element(s) may be processed simultaneously to speed up the conversion and/or insertion process.

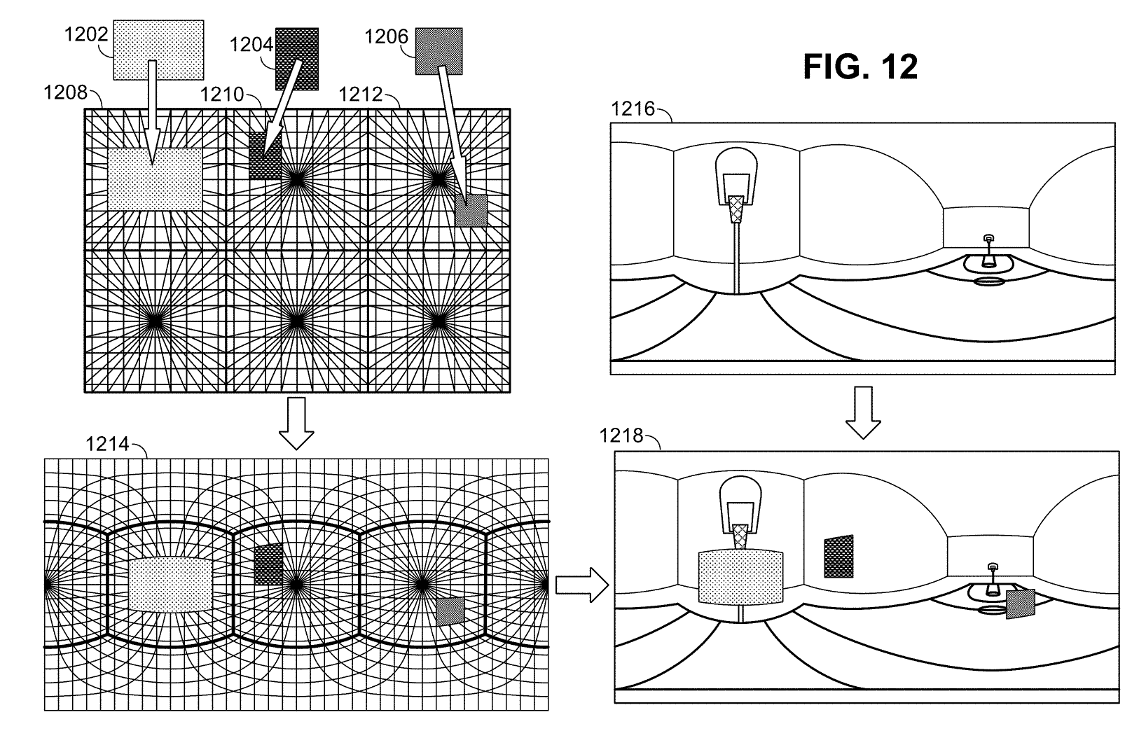

FIG. 12 illustrates such an example in which three media elements 1202, 1204, 1206, which may include text information, traffic information, news, video, chat or other media elements, are inserted into the 360-degree VR. For example, three elements may be pasted onto three cube map faces 1208, 1210, 1212, respectively. The cubemap is converted to an ERP representation 1214. Mapped video containing the three media elements is overlaid with an immersive 360-degree video 1216 to generate a composite video 1218, and the composite video 1218 may be presented to the user depending on the viewport. Rectilinear media element may be inserted dynamically in real time.

In some embodiments, multiple 2D rectilinear videos are placed in one face of the cubemap. Metadata can be used to indicate which viewable area belongs to which video. The resolution of cube map face may be varying (e.g., 960×960 or 1920×1920). The conversion may select the cubemap face size to accommodate some or all rectilinear videos. For example, the cubemap face size may be a least common multiplier of the resolutions of multiple rectilinear videos to be converted. The mapped content may be rendered independently from the 360-degree video. The projected rectilinear video may be placed at any position of the 360-degree video. The projected video may be composited using alpha blending.

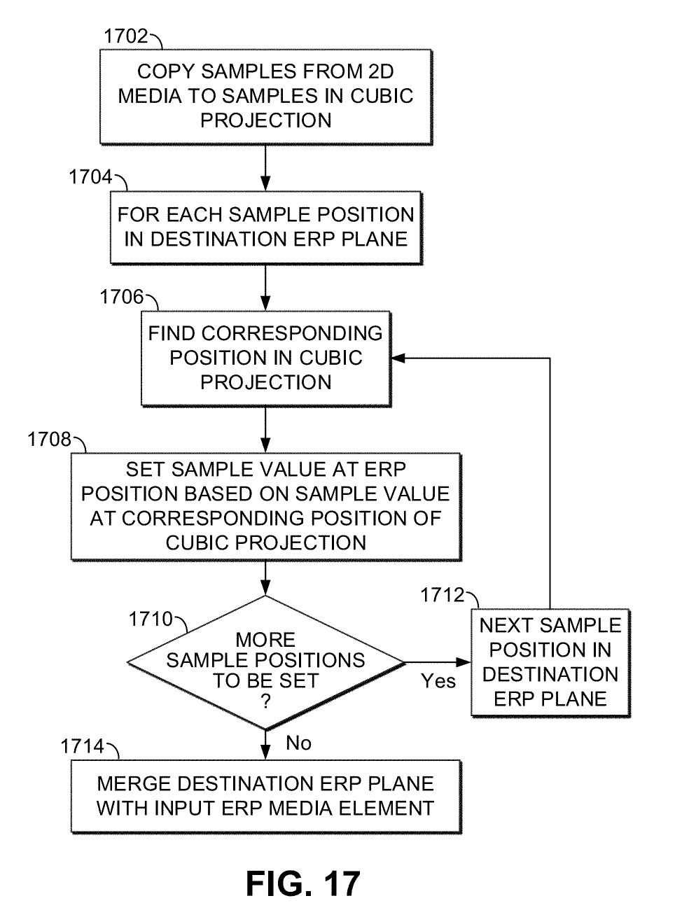

The methods described herein may be implemented using a variety of techniques. In some embodiments, as illustrated in FIG. 17, a rectilinear media element is inserted into a face of a cubemap representation (or, in alternative embodiments, to a rectilinear portion of a different projection format). For example, in step 1702, samples at positions (m_{2D}, n_{2D}) of the rectilinear media element are copied to corresponding positions (fₛ, mₛ, nₛ) on a cubic source projection plane, where fₛ is an index identifying a particular face and mₛ, nₛ are coordinates within that face. The positions (fₛ, mₛ, nₛ) that correspond to positions (m_{2D}, n_{2D}) may be found using, for example, a mapping that includes translation, scaling, and/or rotation. The cubemap representation is converted to an equirectangular representation. To do this, in some embodiments, for each sample position in the destination equirectangular plane (1704), the corresponding sample position (fₛ, mₛ, nₛ) on the cubic source projection plane is found in step 1706. This may be done by first mapping the position (fₛ, mₛ, nₛ) to the corresponding (X, Y, Z) in a 3D coordinate system and subsequently finding the corresponding sample position (fₛ, mₛ, nₛ) on the cubic source projection plane. In step 1708, the sample value at (f_{d}, m_{d}, n_{d}) is set based on the sample value at (fₛ, mₛ, nₛ). Step 1708 may include interpolation if, for example, the values mₛ, nₛ are not integer values. If there are additional sample positions to be set (step 1710), the method may proceed (step 1712) with the next sample position to be considered. In some embodiments, the method of FIG. 17 does not loop through every sample position in the destination equirectangular plane. For example, the method may loop only through those samples that are in a portion of the equirectangular plane that corresponds to a users viewport, or only through those samples that have been determined to correspond to a portion of the rectilinear media element. In some embodiments, positions in the destination plane that do not correspond to any position in the rectilinear media element may be assigned an alpha channel value of zero. If there are no additional samples to be set, the method may proceed in step 1714 to merging of the resulting equirectangular destination plane with an input equirectangular media element, e.g. using alpha compositing.

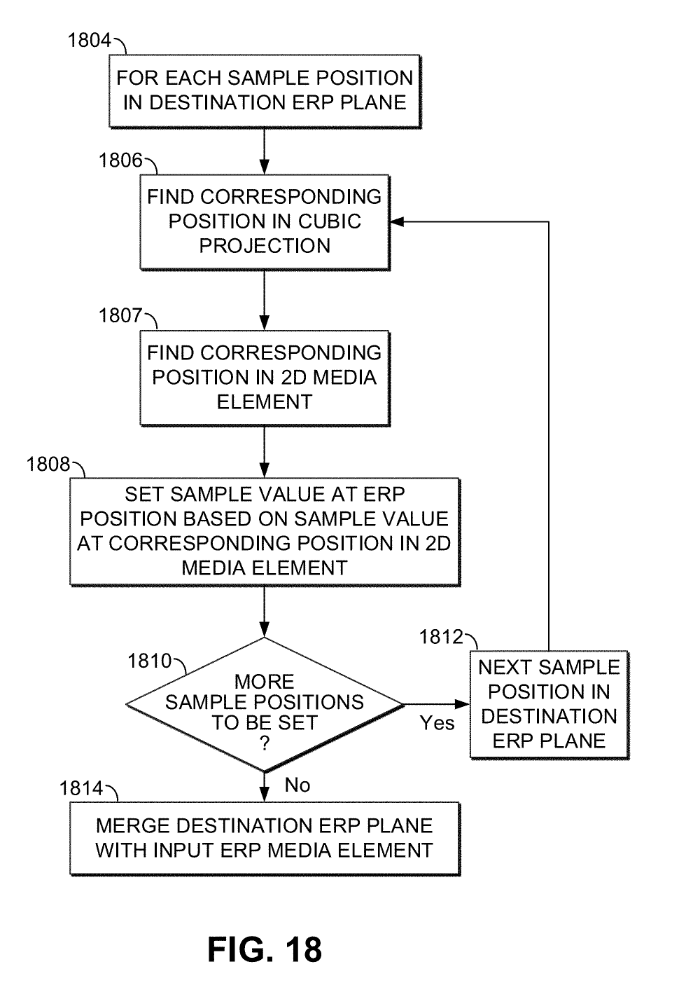

In some embodiments, as illustrated in FIG. 18, an input rectilinear media element is mapped to an equirectangular representation. In the embodiment of FIG. 18, for each relevant sample position in the equirectangular destination plane (1804), the corresponding sample position (fₛ, mₛ, nₛ) on the cubic source projection plane (or alternatively, to an equirectangular portion of a different projection format) is found in step 1806. This may be done by first mapping the position (fₛ, mₛ, nₛ) to the corresponding (X, Y, Z) in a 3D coordinate system and subsequently finding the corresponding sample position (fₛ, mₛ, nₛ) on the cubic source projection plane. In step 1807, a position (m_{2D}, n_{2D}) in the rectilinear input media element is found that corresponds to the sample position (fₛ, mₛ, nₛ) on the cubic source projection plane. This may be done using, for example, a mapping that includes translation, scaling, and/or rotation. In step 1808, the sample value at (f_{d}, m_{d}, n_{d}) is set based on the sample value at (m_{2D}, n_{2D}) in the rectilinear input media element. Step 1808 may include interpolation if, for example, the values m_{2D}, n_{2D} are not integer values. If there are additional sample positions to be set (step 1810), the method may proceed (step 1812) with the next sample position to be considered. In some embodiments, positions in the destination plane that do not correspond to any position in the rectilinear media element may be assigned an alpha channel value of zero. If there are no additional samples to be set, the method may proceed in step 1814 to merging of the resulting equirectangular destination plane with an input equirectangular media element, e.g. using alpha compositing.

In some embodiments, the methods of FIGS. 17 and 18 do not loop through every sample position in the destination equirectangular plane. For example, the methods may loop only through those samples that are in a portion of the equirectangular plane that corresponds to a user's viewport, only through those samples that have been determined to correspond to a portion of the rectilinear media element, or only through samples that satisfy both of those conditions, among other embodiments.

The methods of FIGS. 17 and 18 both make use of two mappings: (i) a mapping between a rectilinear media element and a rectilinear representation (such as a rectilinear portion of a cubemap) and (ii) a mapping between the rectilinear projection and an equirectangular representation. However, as seen from the examples of FIGS. 17 and 18, these mappings may be used in different orders to perform the conversion of the rectilinear media element to an equirectangular representation.

Some embodiments use an alpha map or other significance map to indicate which samples in the rectilinear representation represent the mapped content of the input rectilinear media element and which samples are still blank/empty. Such an alpha/significance map may be generated at various different stages. In some embodiments, the alpha/significance map is generated in the intermediate rectilinear representation, and the alpha/significance map is transformed to the equirectangular format. The transformed alpha/significance map may then be used when generating the merged media element.

The VR devices may provide a display on the headset which may be composed of one or more layer(s). One of the layers may be the primary layer or the default layer. Other layers may be included, such as HUD (head-up display) layers, information panel layers, and/or text label layers. One or more layers may have a different resolution using a different texture format or different field of view (FOV) or size. One or more layers may be in mono or stereo. Some or all active layers of a frame may be composited from back to front using, for example, pre-multiplied alpha blending. A user application may configure one or more parameters to control how to composite some or all layers together. For example, the user application may determine whether a layer may be head-locked (e.g., whether the information in that layer may move along with the head and may stay in the same position in the render viewport), transparency, FOV and/or resolution of the layer. Based on the configuration specified by the user application, the compositor may composite (or otherwise blend) some or all layers to produce the final viewport image. The compositor may perform time warp, distortion and/or chromatic aberration correction on the layer separately before blending the layers together.

In some embodiments, a UI design is used to enable personalized VR that may allow people to interact with the virtual world and/or real world. VR may provide flexible environment such as 360-degree and/or multiple layer structure for the UI layout design. UI features and/or layout designs may be provided in exemplary embodiments for personalized VR.

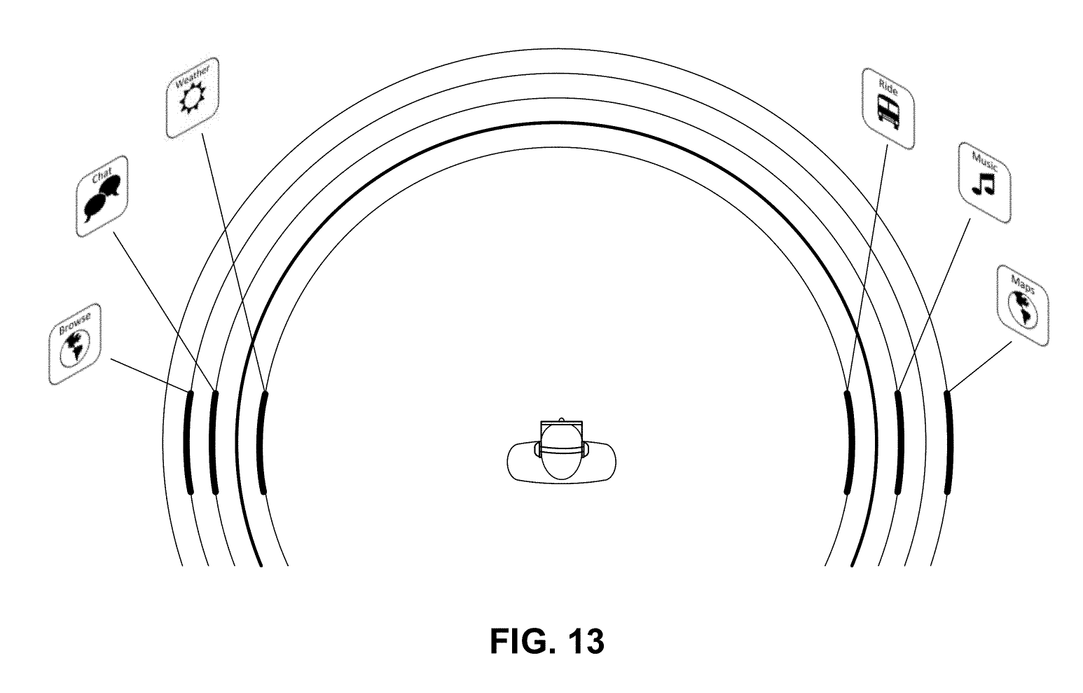

Multiple App UI such as icons may be assigned to a different layer (e.g., UI layer) than the layer to which the primary 360-degree video may belong. The user may use voice, gesture control, eyeball tracking and/or haptic control to set the UI layers depth, visible, transparency and/or invisible during the VR presentation, as shown in FIG. 13. For example, the visibility or activation of particular UI layer may be enhanced when the user is focusing on a particular layer. The user may speak the layer's identifier (e.g., “my movies,” “my games,” or “my documents”) where the identifier may be the metadata embedded in the layer and may be identified, for example, via voice recognition. The user may touch a layer to highlight and/or activate the corresponding layer.

The user may scale up or down the UI icons to viewport field of view. The user may drag the UI layer away from the viewport or into the viewport. The application may allocate the UI layer to portion (e.g., the least viewed portion) of 360-degree sphere depending on the VR content characteristics and/or viewing statistical analysis. For example, during a paid commercial advertisement, the application may prohibit overlaying UI icons. For other example, during a VR movie, the application may prohibit overlaying UI icons at some locations of the scene that may deem important for storytelling. The decision to re-position the UI layer may be driven by artistic-intent metadata embedded in the VR content. Based on, for example, the interesting or high priority areas and/or viewports specified in the artistic intent by, for example, the content producer or director, the overlaid UI layers or other presentation layers may be moved to other position of 360-degree space and/or turned in transparent layer (e.g., high transparent layer). The overlaid UI layers may be grouped into a 3D digital object (e.g., small 3D digital object) to enhance immersion of typical scenes and/or viewports. A visible and/or touchable interface may be provided to the user to enable or disable some or all UI layers to be presented in the VR environment. Enabled UI layers may be activated by the user and/or applications with granted permissions.

A particular UI layer and/or presentation layer may be highlighted and/or turned in opaque (100% opaque). The particular UI layer may be pushed to the user's viewport under certain circumstances. An example of the circumstances may be for an emergency alert. The emergency alert and/or emergency alerting control may be driven by the event signal from the central server such as emergency alert system, ad server, local area network (LAN) or wide area network (WAN) administrator, and/or the home gateway. The home gateway may be connected to some or all home devices and/or may operate to deliver a reminder and/or alert to some or all VR users residing in the home network.

Activation and/or de-activation events may be assigned to different UI icons. For example, depending on application events such as notification, activation and/or timeout, icons may be presented at a transparency level that is between fully transparent and fully opaque. For example, a recently activated icon (e.g., an icon just clicked on by the user, a call that just came in, an alarm that just went off) may appear opaque (e.g., 100% opaque) in the personalized VR scene. De-activated icons (e.g., an icon that has been de-activated by the user, an icon that may have been timed-out because the icon has not been selected by the user for a long time) may become partially or fully transparent and/or may be invisible. An icon may be associated with a transparency level (e.g., between 0% -100%). To re-activate transparent icons (e.g., 100% transparent icons), a user may perform a dedicated action (e.g., click a button on the VR controller and/or a button on the HMD) to bring the transparent icons (e.g., 100% transparent icons) back into visible icons.

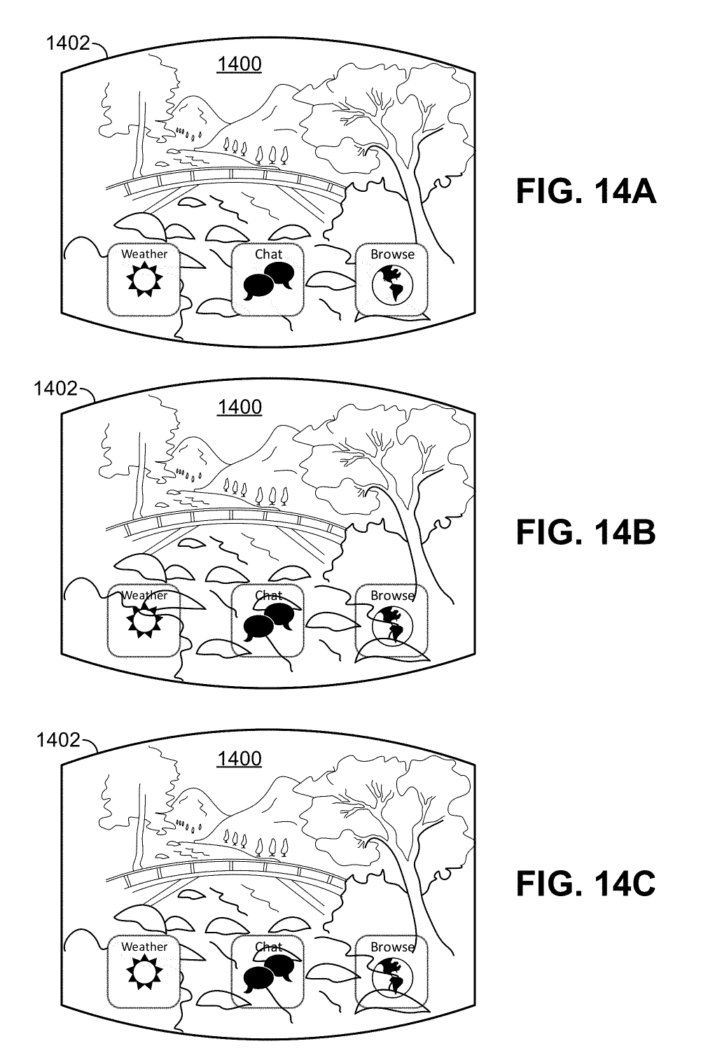

FIGS. 14A-C illustrate examples of UI icons configured as opaque and/or transparent with respect to a background 1400 visible in a viewport 1402. In the configuration of FIG. 14A, all three icons (“Weather,” “Chat,” and “Browse”) are opaque. In the configuration of FIG. 14B, all three icons are at least partially transparent, which may be the result of none of the three icons having been selected (e.g. for more than a threshold period of time). In the configuration of FIG. 14C, which may occur in response to selection of the “Weather” icon, the “Weather” icon is opaque while the other icons remain at least partially transparent.

The UI may be implemented a polyhedron, which may be a 3-dimensional polyhedron. Application, media elements and/or tools may be assigned to one polygonal face. Polyhedron with flat polygonal faces, such as tetrahedron, octahedron and/or Rubik's cube may be used. Polyhedron icon may offer access to one or more app(s), media element(s) and/or tool(s) from a UI.

One or more media elements such as text, image, video and/or CGI objects may be allocated to a layer, which may be the same layer. The depth, which may be same depth, and/or transparency level may be assigned to one layer. Some or all media elements belonging to the same layer may share the same values of layer attributes. Layer attributes may be depth and/or transparency level. Layer attributes may be pre-configured and/or configured on the fly based on user's preference and/or application.

The VR environment may include one or more spherical VR(s) and/or 360-degree layers. Spherical VR and/or 360-degree layers may present different media content. A UI may be provided to the user allowing the user to adjust the attributes (e.g., depth and/or transparency) of one or more layers. For example, such a control to adjust the attributes may be implemented using a sliding bar. A VR and/or 360-degree layer may be extracted via a sliding bar. The depth and/or transparency of one or more layer may be adjusted by the sliding bar and/or other interface.

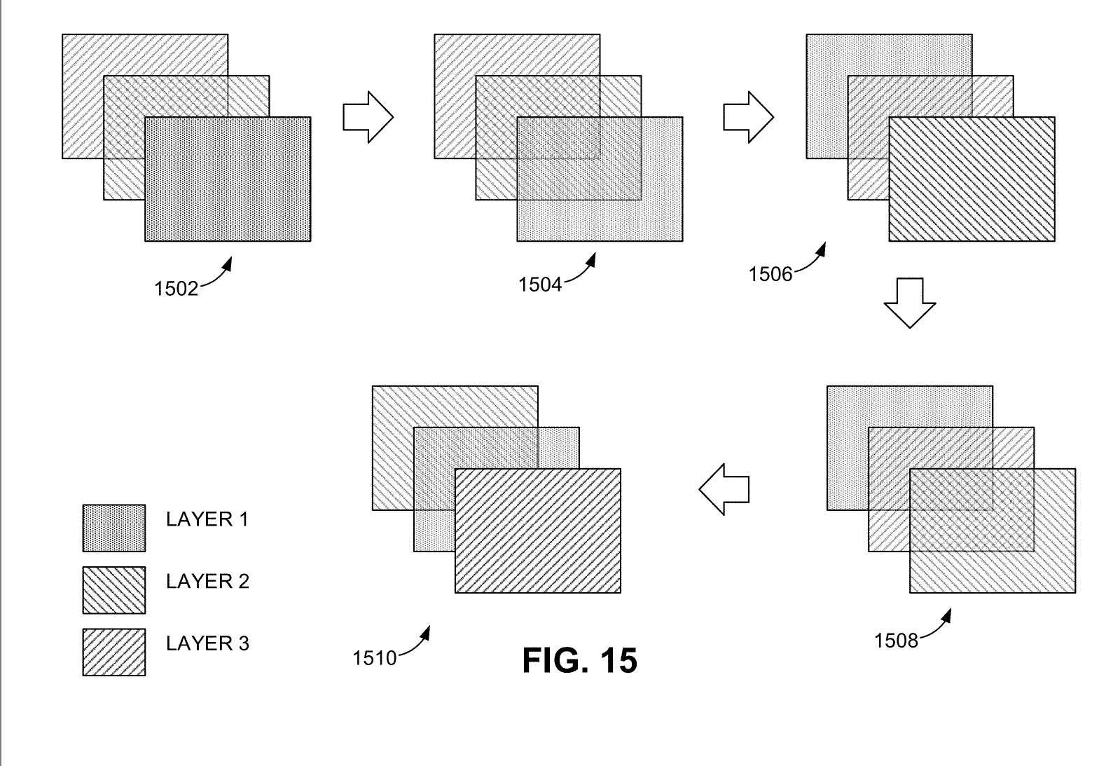

FIG. 15 illustrates an example of multiple overlapped VR and/or 360-degree layers. In configuration 1502, media elements in layer 1 are opaque, and those in layers 2 and 3 are at least partially transparent (semi-transparent). In configuration 1504, media elements in all layers are semi-transparent. In configuration 1506, layer 2 has been moved to the foreground and media elements therein are opaque, while media elements in layers 1 and 3 are semi-transparent. In configuration 1508, media elements in all layers are semi-transparent. In configuration 1510, layer 3 has been moved to the foreground and media elements therein are opaque, while media elements in layers 1 and 2 are semi-transparent.

One or more layers may be promoted to the front and/or pushed to the back via a sliding bar or other user interface. The transparency of the primary layer may be adjusted through such UI. Adjusting the attributes described herein may be controlled using other means of user interaction, such as gesture control.

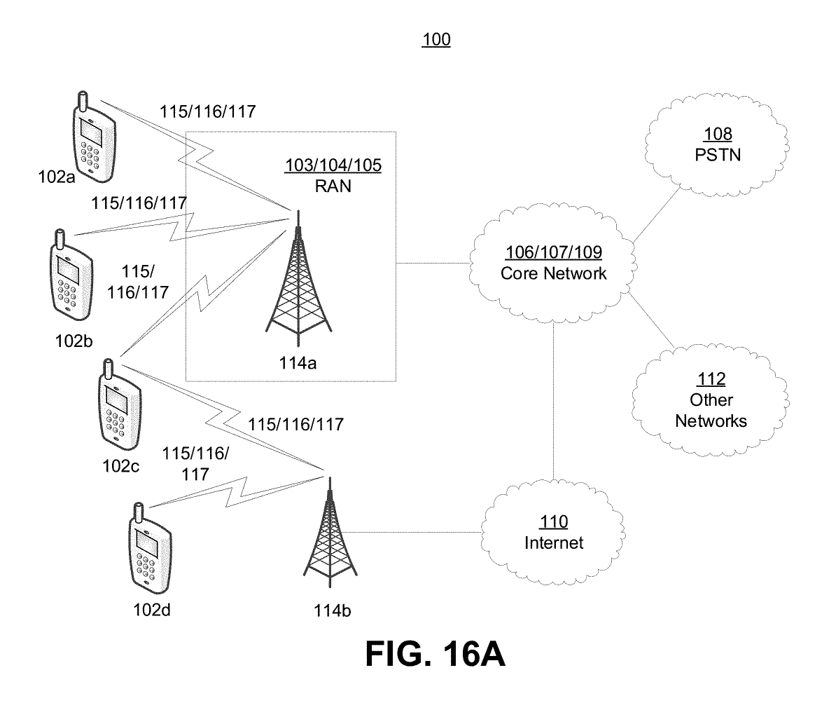

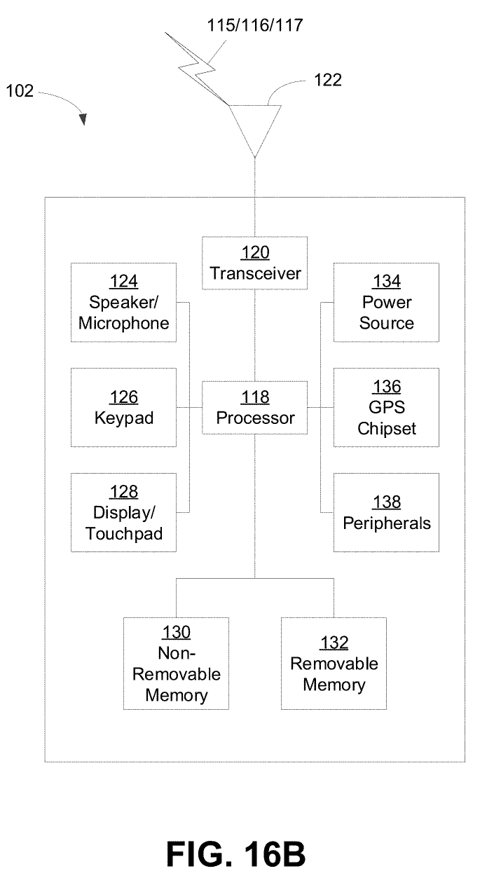

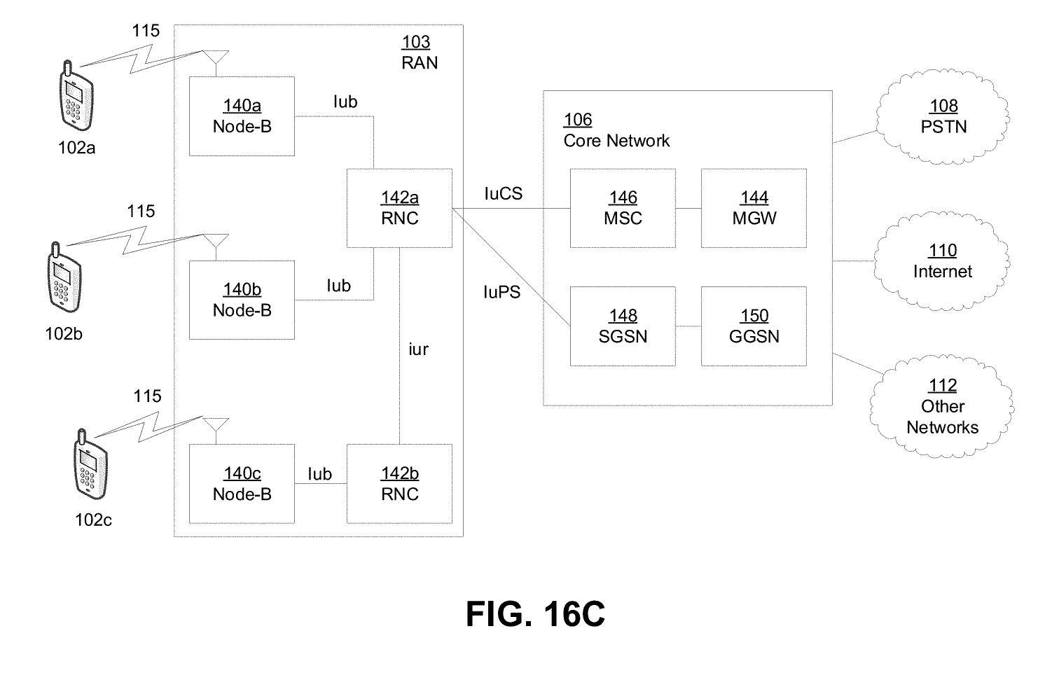

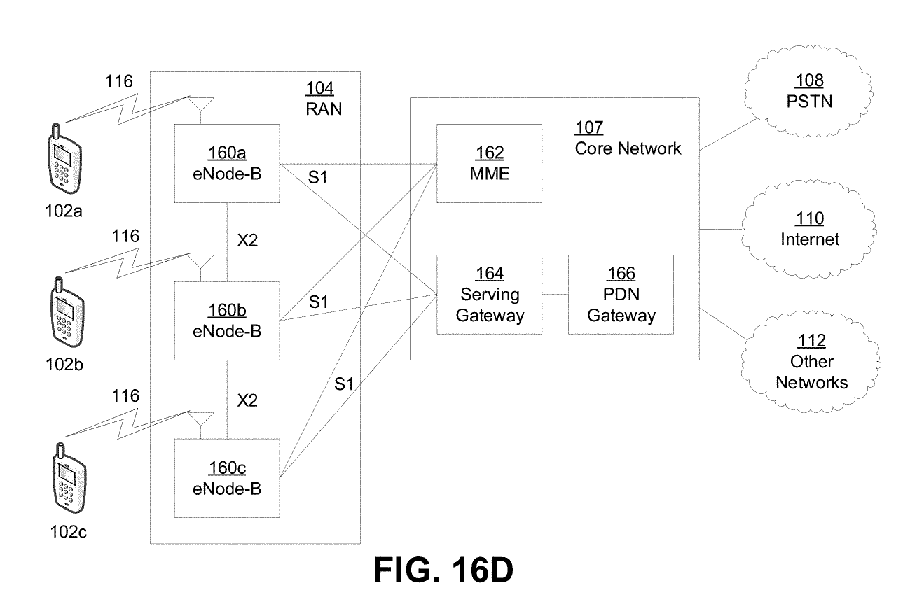

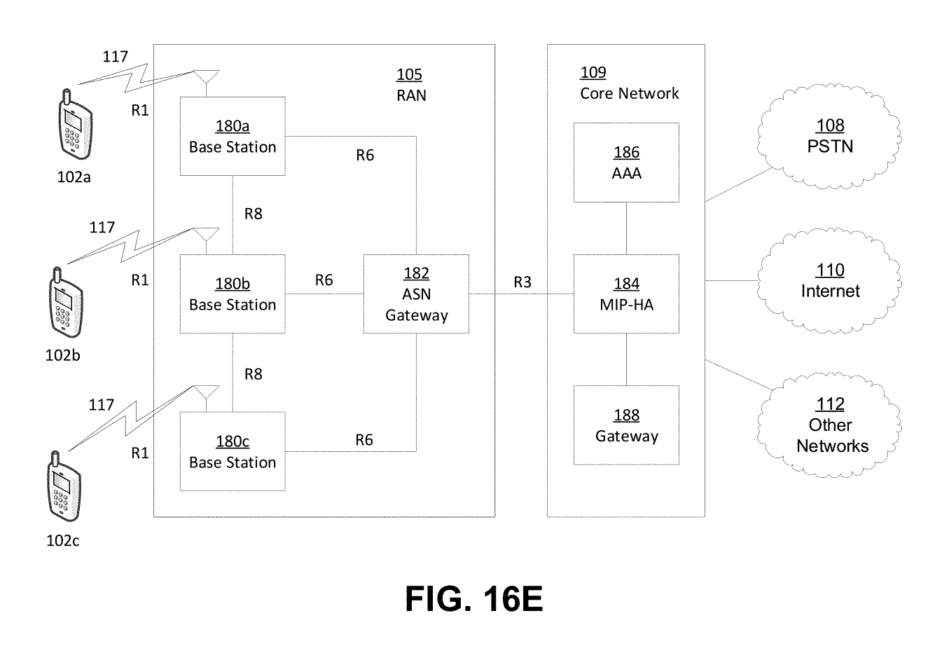

FIG. 16A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 16A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 16A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 16A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 16A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 16A may be configured to communicate with the base station 114a, which may employ a cellular-based radio technology, and with the base station 114b, which may employ an IEEE 802 radio technology.

FIG. 16B is a system diagram of an example WTRU 102. As shown in FIG. 16B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 16B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 16B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 16B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 16C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 16C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 16C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an lur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 16C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuPS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an luPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 16D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 16D, the eNode-Bs 160a, 160b, 160c may communicate with one another over an X2 interface.

The core network 107 shown in FIG. 16D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 16E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 16E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 16E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 16E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method comprising:
inserting at least one input rectilinear media element to a face of a cubemap representation;
converting the cubemap representation to an equirectangular representation of the rectilinear media element; and
merging the equirectangular representation of the rectilinear media element with an equirectangular representation of an input spherical media element to generate a merged spherical media element.

2. The method of claim 1, further comprising displaying at least a viewport portion of the merged spherical media element by a client device.

3. The method of claim 2, wherein the client device comprises a head-mounted display, and wherein the viewport portion is determined based at least in part on an orientation of the head-mounted display.

4. The method of claim 2, wherein the converting and the merging is performed by the client device.

5. The method of claim 2, wherein the converting is performed by a server remote from the client device.

6. The method of claim 2, wherein the merging is performed only for the viewport portion.

7. The method of claim 1, wherein the input rectilinear media element is a user interface element.

8. The method of claim 7, wherein user interface elements for different applications are inserted to different faces of the cubemap representation.

9. The method of claim 1, wherein the merging comprises overlaying the equirectangular representation of the rectilinear media element on the equirectangular representation of the input spherical media element.

10. The method of claim 1, wherein the merging comprises alpha compositing of the equirectangular representation of the rectilinear media element with the equirectangular representation of the input spherical media element.

11. The method of claims 1, wherein the input rectilinear media element is a two-dimensional media element.

12. The method of claim 1, wherein the input rectilinear media element is a two-dimensional image.

13. The method of claim 1, wherein the input rectilinear media element is a two-dimensional video.

14. A method comprising:
selecting a first mapping of an input rectilinear media element to a position in a first projection format, the position corresponding to a rectilinear portion of the first projection format;
converting the rectilinear media element to an equirectangular representation by applying the first mapping and a second mapping, the second mapping being a mapping between the first projection format and the equirectangular representation; and
merging the converted rectilinear media element with another equirectangular media element to generate a merged media element.

15. The method of claim 14, further comprising displaying at least a viewport portion of the merged media element by a client device.

16. A method comprising:
mapping a rectilinear input media element to an equirectangular representation by a method including, for each of a plurality of equirectangular sample positions in the equirectangular representation: (i) mapping the respective equirectangular sample position to a corresponding cubemap position in a cubemap representation, (ii) mapping the corresponding cubemap position to an input sample position in the input media element, and (iii) setting a sample value at the respective equirectangular sample position based on a sample value at the input sample position; and
merging the equirectangular representation of the input media element with an equirectangular spherical media element to generate a merged spherical media element.

17. The method of claim 16, further comprising displaying at least a viewport portion of the merged spherical media element by a client device.

18. The method of claim 17, wherein the client device comprises a head-mounted display, and wherein the viewport portion is determined based at least in part on an orientation of the head-mounted display.

19. The method of claim 16, wherein the input rectilinear media element is a two-dimensional image.

20. The method of claim 16, wherein the input rectilinear media element is a two-dimensional video.
